(19) United States
(12) Patent Application Publication
(10) Pub. No.: US 2015/0347932 A1
(43) Pub. Date: Dec. 3, 2015

(54) Secure 3-D Printing Platforms, Systems, and Methods

(71) Applicant: Visa International Service Association, San Francisco, CA (US)

(72) Inventors: Theodore Harris, San Francisco, CA (US); Matthew Quinlan, Danville, CA (US); Scott Edington, Arlington, VA (US); Patrick Faith, Pleasanton, CA (US)

(21) Appl. No.: 14/621,081

(22) Filed: Feb. 12, 2015

Related U.S. Application Data
(60) Provisional application No. 62/004,616, filed on May 29, 2014.

(51) Int. Cl. G06Q 10/06; H04L 9/32

(52) U.S. Cl. CPC G06Q 10/06; H04L 9/3231; G06Q 2220/10

(57) ABSTRACT

Systems, methods, and platforms can be configured to provide services and devices that powers, controls and authenticates 3-D printed objects, such as through an adaptive control module for unique 3-D printer products. Secure processing of product specifications can also be performed to help maintain the anonymity of confidential user information used in the manufacture of products.

### PRIORITY

This application claims priority to U.S. provisional patent application Ser. No. 62/004,616 filed May 29, 2014, entitled “3-D Printing Platforms, Systems, and Methods.” The entire contents of the aforementioned application is expressly incorporated by reference herein.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to instant manufacturing, and more particularly to 3-D printing systems and methods.

### BACKGROUND

3-D printing is growing in popularity as it promises instant manufacturing in such locations as the home or small office. As more products move to 3-D printing, it will be more difficult for designers to take a share in revenue generated by their designs. Ensuring secure utilization of their designs may be an issue for designers and users.

### SUMMARY

Embodiments disclosed herein provide services and devices that powers, controls and authenticates 3-D printed objects, such as through an adaptive control module for unique 3-D printer products. Also disclosed herein is a comprehensive environment for instant manufacturing, such as for secure instant manufacturing of pharmaceutical products.

As another example, systems and methods are disclosed for creating a unique, encrypted finger-print for each 3D printer controller that require decryption in order to print select products. This enables manufactures to send product specifications without running the risk of those specifications being pirated.

As still another example, systems and methods are disclosed for secure instant manufacturing. A product specification is transmitted that contains instructions to an instant manufacturing controller for manufacturing a product. Encrypted fingerprints are stored that are unique to the instant manufacturing controller. The securing processing involving the product specification includes decryption of a unique, encrypted finger-print being required for an instant manufacturing controller to manufacture the product based on the product specification.

### BRIEF DESCRIPTION OF THE DRAWINGS

The accompanying appendices and/or drawings illustrate various non-limiting, example, innovative aspects in accordance with the descriptions below.

FIGS. 1-4 depict various embodiments of 3-D printing environments.

FIGS. 5 and 6 are block diagrams depicting embodiments of secure approaches for device components, such as those used within 3-D printers.

FIGS. 7 and 8 are block diagrams depicting 3-D printing services.

FIGS. 9 and 10 depict example computer and software components that can be used with the operations described herein.

### DETAILED DESCRIPTION

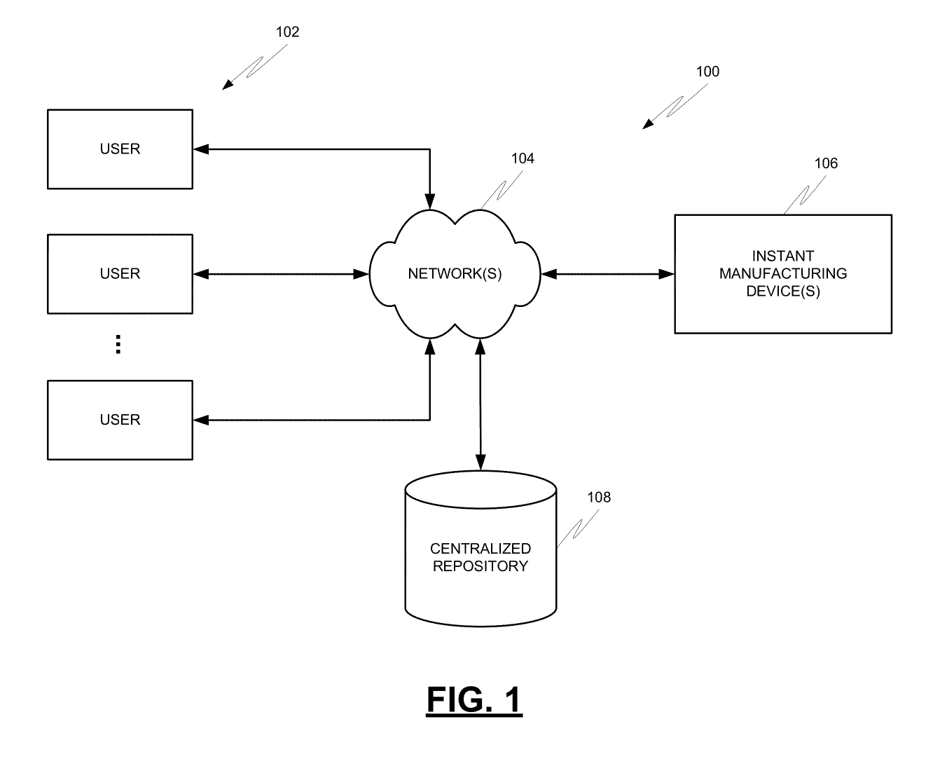

FIG. 1 depicts at 100 a 3-D printing networked environment where users 102, such as consumers and suppliers of 3-D product specifications, can interact over one or more networks 104. Consumers can use the networked environment to search for the designers' printing specifications that best suit their needs in producing products within their homes or offices. Once located, the designer's specifications can be provided over the network to the consumer so that they can be printed/manufactured via 3-D printers or other similar type devices 106. A centralized repository 108 can be used within the networked environment for supplying information needed by the specifications for generating such products.

There are many uses for such a 3-D printing networked environment 100. Homes can be equipped with instant manufacturing capability, such as with 3-D printing capability. Example products that can be generated from 3-D printers include toys, household goods, pharmaceuticals, clothes, food, books, etc. Essentially, anything three-dimensional can be manufactured with such technology. The benefits of 3-D printing are shown, for example, in parents' willingness to use 3-D printing for their children's toys. With such direct manufacturing capability, parents know what materials are being utilized in the toys they give their children.

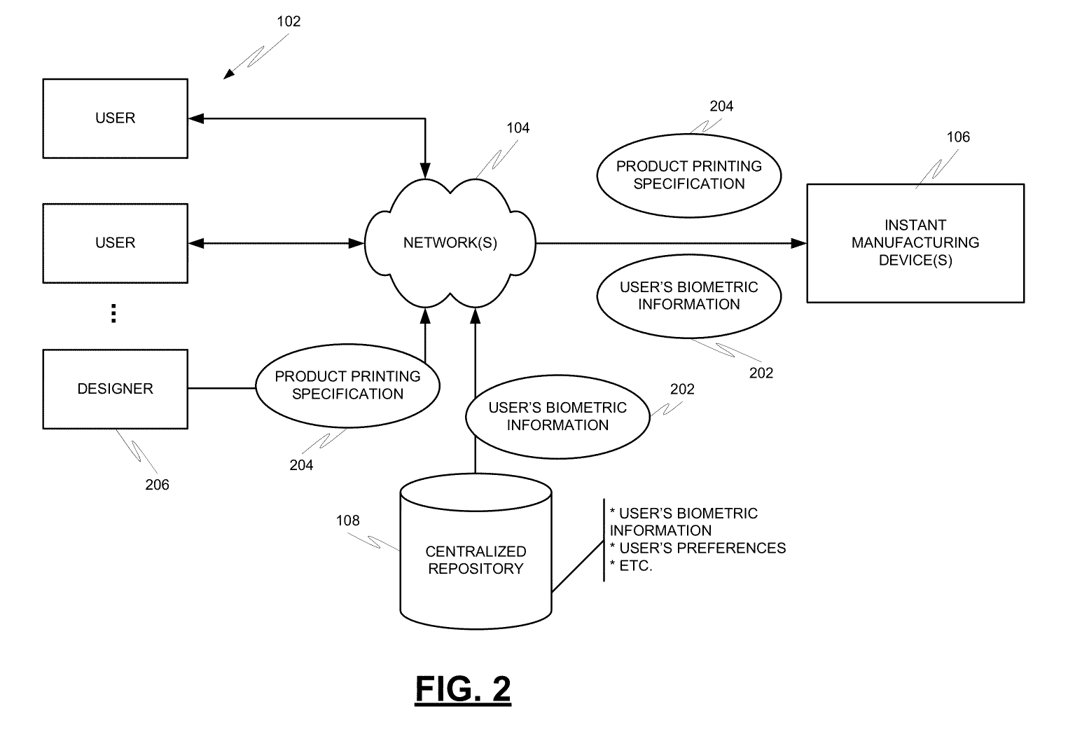

FIG. 2 illustrates that the centralized repository 108 can store many different types of data, such as biometric information 202 needed by a designer's specification 204. The centralized location can allow users to provide their information (e.g., biometric information 202) to the repository for use within a marketplace type environment. Such information can be collected and assembled to provide manufacturing capability for designers. Examples of biometric data for customizing product specifications 204 includes: physical details (e.g., weight, height, etc.) as well as user's preferences, such as typically preferred user colors. This approach also allows information to be maintained as private since the designers (e.g., designer 206) will not have access to people's private information (e.g., biometric information, buying preferences, etc.). Rather the designers can supply specifications 204 to direct a 3-D printer to manufacture a particular product, and information can be retrieved separately from the centralized repository and sent to the user's 3-D printer where the information is used in conjunction with the designer's specification 204 for printing a particular product. In this way, the user does not have to provide their personal information to a designer so that a product can be produced.

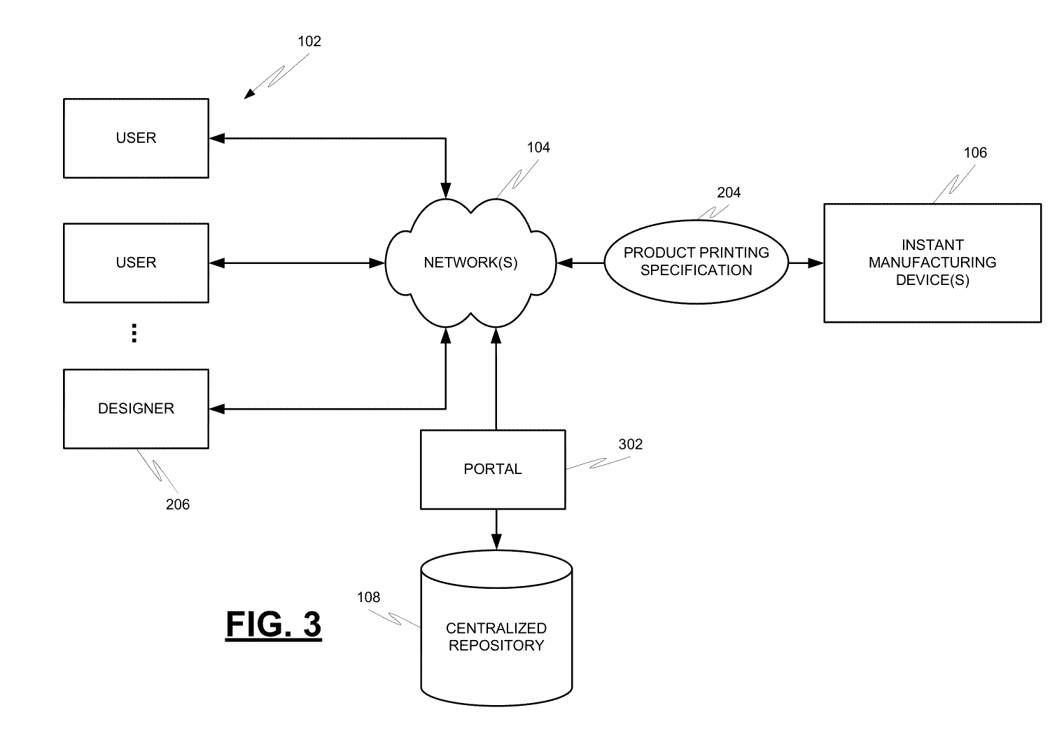

FIG. 3 depicts a portal 302 for managing access and retrieval operations with respect to the centralized repository 108. This helps to ensure that information is protected by controlling access and retrieval to this sensitive information. This includes regulating how designers' specifications and the users' personal information can be managed so that the user's information can be protected.

An approach can include the user receiving the designer's specification 204, and based upon the data requirements of the specification 204, the user's 3-D printer system sends the request to the portal so that the proper information can be retrieved and sent back to the user's 3-D printer system. Thereupon, the desired product can be produced by a 3-D printer system. In this way, the maintainer of the centralized repository 108 operates as an identity broker within the 3-D printing networked environment. Other embodiments can include the central repository 108 storing both the personal user information as well as different design specifications. The portal 302 can examine any requested design specifications for what additional information is needed or at least can be used to assist in determining what preferences (e.g., color-wise, etc.) the consumer might wish when manufacturing the product via their 3-D printer.

By operating as an identity broker, the maintainer of the centralized repository 108 can assist in creating a fully integrated product specification that incorporates: physical design, documentation, instructions, electronic component design. The portal 302 can also operate as a product marketplace that provides easy and affordable access to the product specifications for manufacturing items using a 3-D printer or other instant manufacturing systems.

The repository 108 can include one or more databases for storing user information for use in printing products securely. The repository 108 can be structured as a relational database management system wherein the information of each user is stored separately. However, storage approaches other than relational database management systems can be used, such as object-oriented databases. Additionally, the data can be compressed in the sense that a significant amount of biometric and personal data will be common to a number of people. In these embodiments, a wireframe type data structure can be utilized to store data common to most people (e.g., most people have 10 fingers and toes) and the differences are what is stored for each user.

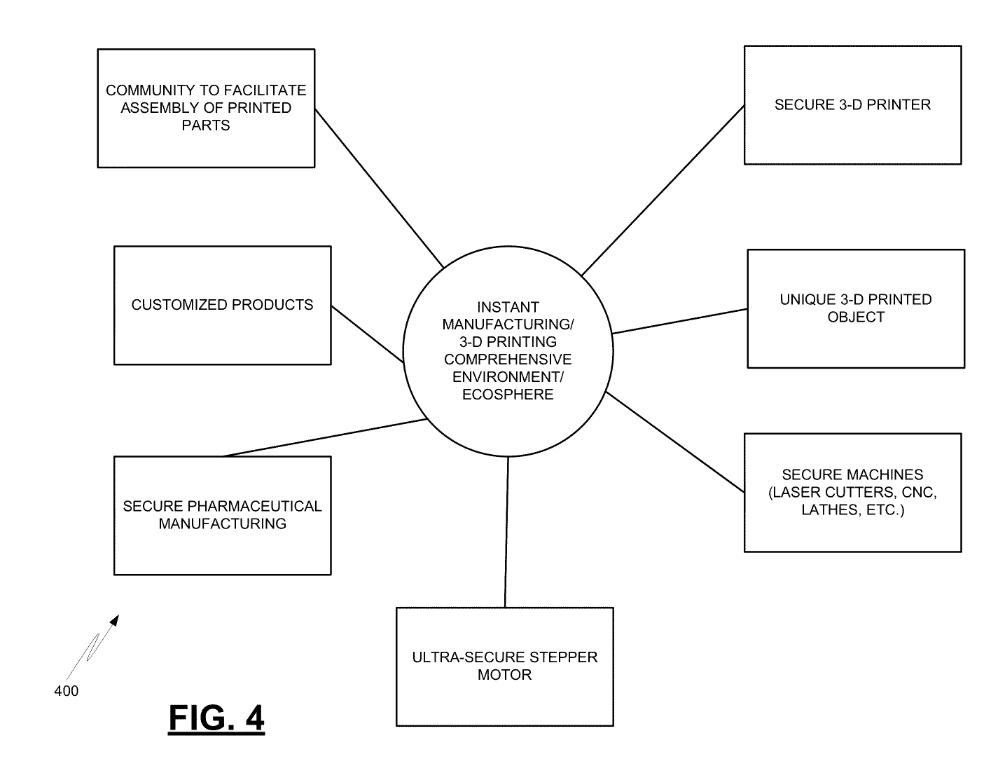

3-D printing can produce multiple parts that need to be assembled. This can introduce complexity into the assembly process. For simple products, assembly should not be a significant concern. However, products that have multiple interconnecting parts can require multi-step, complicated assembly. To facilitate assembly, a community environment can be established through the comprehensive 3-D printing environment depicted at 400 in FIG. 4. People within the community may acquire specialty 3-D printing and assemble knowledge as their experience grows with the 3-D printing process over time. The designers operating within the community can be their own advertisers as well as operate as merchants in selling product specifications.

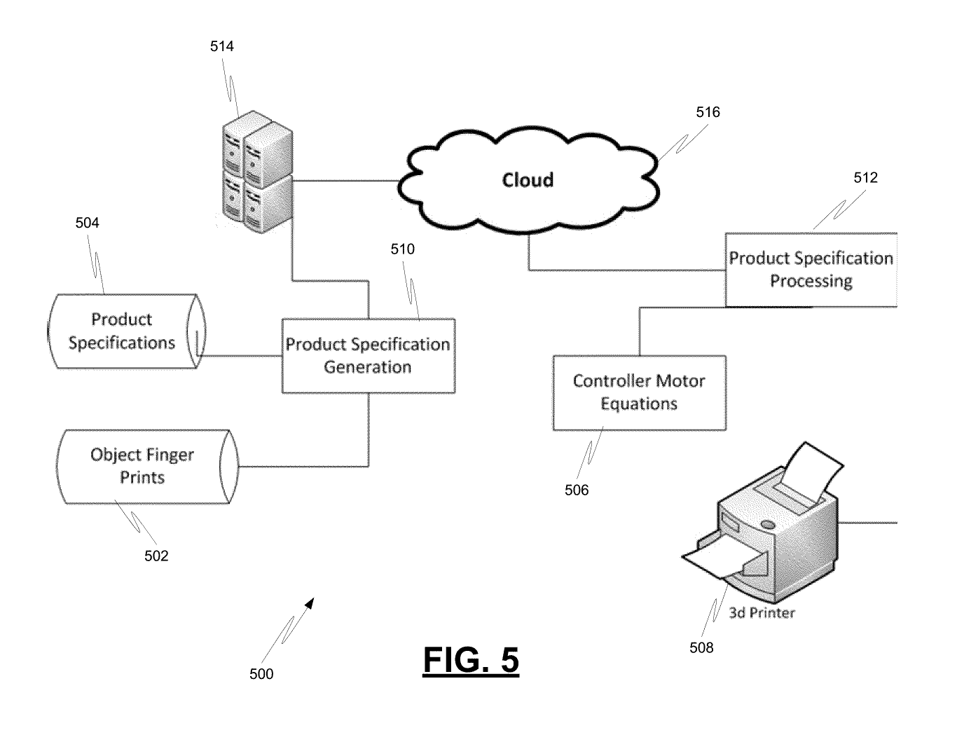

Security in 3-D printing can be accomplished in different ways. For example, FIG. 5 shows a secure 3-D printer controller system at 500. The system 500 creates a unique, encrypted finger-print 502 for each controller associated with a 3D printer and would require decryption to print select products. This would enable manufactures to send product specifications 504 without running the risk of those specifications being pirated. Such security would increase the number of people using the system since security is an issue in 3-D printer networked applications.

The product specification generation process 510 can include at random intervals in the product specifications 504 inert commands (e.g., commands that instruct the machine to do nothing) to further obscure the final product specification.

A security approach can include product specification processing 512 of a specification transmitted by server(s) 514 over a cloud network 516. The product specification processing processes specific equations 506 for the 3-D printer 508, such as but not limited to processing chaotic maps that are sensitive to parameter misspecifications.

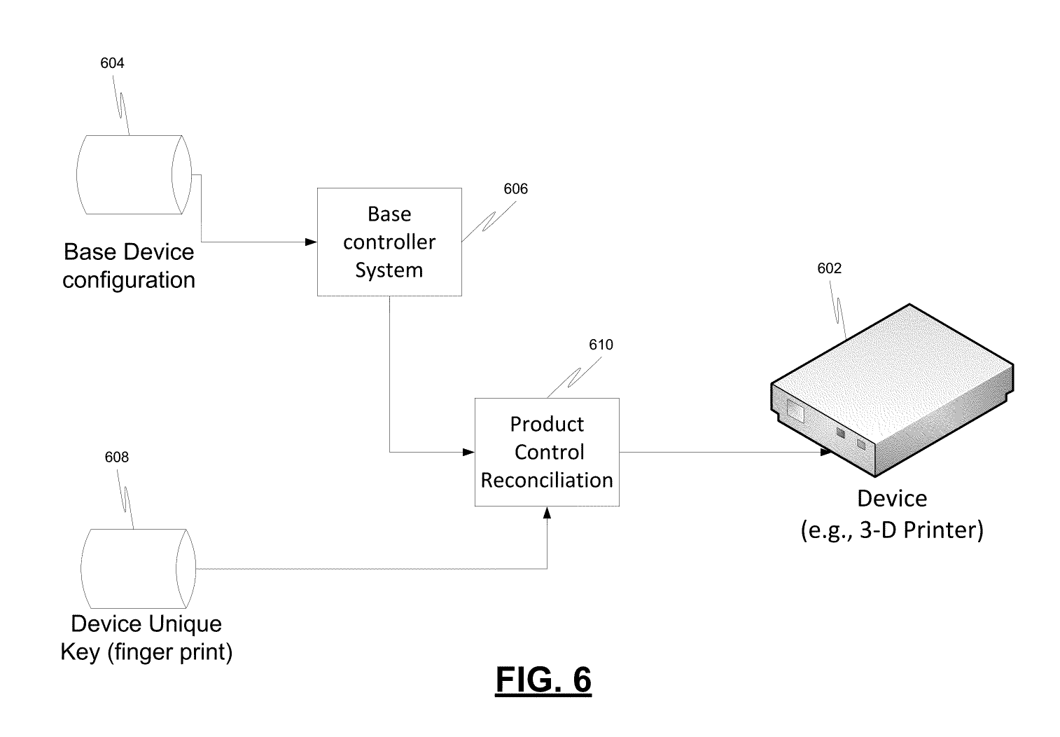

FIG. 6 depicts another example of a secure environment where, control and power modules of a device 602 can be adapted to a unique product (to be manufactured) as derived off of a base product configuration 604. This control module could contact the service of the identity broker once a product has been assembled to download control codes. These control codes could be unique and encrypted on the device 602 to ensure the commands are not transferred. Once the device's uniqueness is verified by the identity broker, its custom code could be transmitted and “branded” into the control unit 606.

Each subcomponent for a product could be unique such that the device 602 will not work properly unless the generated command set is uploaded. The component's variation works as an encryption key 608. To copy a design, one would have to receive the control codes and regenerate them for the new device. Networked systems can also deactivate stolen or lost components remotely. The control units could be generic and modular. A user can swap out controllers from products no longer being used.

The types of acceptable variations of the products can be authenticated by the identity broker. The adaptive controller system of the identity broker can be designed to work fully in encrypted space. Similar to secure multiple-party encryption, only set operations and computations may be performed. For example, the base device might specify rotating left to right but due to the uniqueness of the device in question the corrected rotation is right to left. Another example could be modification of the products dimensions which change a start/stop position for the motor. Without the proper start position the motor could not operate.

With reference to FIG. 6, the base module control commands from the base controller system 606 could be encrypted to reconcile at 610 the devices uniqueness with the base commands. This creates a product whose behavior would be difficult to replicate.

The following shows an example of encoding/decoding a device controller commands and the python code used to create the example:

Example of unique device control functions.

Settings

Device Equation: x*z[1]−z[2]+z[3]

Controller functions: x(t)−x(t−1)

Input/Output

Inputs: [0, 1, 2, 3, 4]

Expected Output: [1.0, 0.5, 1.5, 1.0, 2.0]

Tests

Using correct id, id=1.

[1.0, 0.5, 1.5, 1.0, 2.0]

Using incorrect id, id=2.

[−1.0, 0.5, −0.5, 1.0, 0.0]

Below is the python code used to generate the example:

parameter = { 1:{1:.5 , 2:7 , 3:8 } , 2:{1:.5 , 2:2 , 3:1 } }
devicefnc = lambda x, y ,z: x*z[1] − z[2] + z[3]
def movement_fnc(device_id , parameter , inputs ):

movements = [ ]
for ipos, val in enumerate(inputs):

res = devicefnc(val, ipos ,parameter[device_id] )
if len(movements) >= 1:

res = res − movements[ipos −1]

movements.append(res)

return movements

inputs = [0,1,2,3,4]
exp_outputs = [1.0, 0.5, 1.5, 1.0, 2.0]

## Test 1—Correct Key

device_id=1

print movement_fnc(device_id, parameter, inputs)

## Test 2—Incorrect Key

device_id=2

print movement_fnc(device_id, parameter, inputs)

### ADDITIONAL EXAMPLES

The following shows examples of unique print control functions without using the chaotic maps equation for clarity by encoding/decoding a 3-d printer document and the python code used to create the example. In these examples only the x,y,z coordinates are encoded.

Printer Equation and Parameters

Parameters

{1:{1:0.5, 2:7, 3:8}, 2:{1:0.5, 2:2, 3:1}}

Encoding

def encoding (x, y, z, p):
return x*p[1]+p[1], y*p[2]+p[2], z*p[3]+p[3]

Decoding

def decoding (x, y, z, p):
return (x−p[1])/p[1], (y−p[2])/p[2], (z−p[3])/p[3]

### Example 1

Simple example encoding then decoding vertex

Original values: 1.0, 0.0, 0.0

Uniquely Encoded values: (1.0, 7.0, 8.0)

Decoded values: (1.0, 0.0, 0.0)

POC Example with specs to generate cube.

### Example 2

The following examples use the ASCII STL (STereoLithography) file format. The first example is a un-encoded product spec. The second is the same spec encoded for a particular priner.

Base Product Specs

solid cube_corner

facet normal 0.0 −1.0 0.0
outer loop

vertex 0.0 0.0 0.0
vertex 1.0 0.0 0.0
vertex 0.0 0.0 1.0

```
  endloop
endfacet
facet normal 0.0 0.0 −1.0
  outer loop
```

vertex 0.0 0.0 0.0
vertex 0.0 1.0 0.0
vertex 1.0 0.0 0.0

```
  endloop
endfacet
facet normal 0.0 0.0 −1.0
  outer loop
```

vertex 0.0 0.0 0.0
vertex 0.0 0.0 1.0
vertex 0.0 1.0 0.0

```
  endloop
endfacet
facet normal 0.577 0.577 0.577
  outer loop
```

vertex 1.0 0.0 0.0
vertex 0.0 1.0 0.0
vertex 0.0 0.0 1.0

endloop
endfacet

endsolid

Uniquely Encoded Product Specs

solid cube_corner

facet normal 0.0 −1.0 0.0
outer loop

vertex 0.5 7.0 8.0
vertex 1.0 7.0 8.0
vertex 0.5 7.0 16.0

```
  endloop
endfacet
facet normal 0.0 0.0 −1.0
  outer loop
```

vertex 0.5 7.0 8.0
vertex 0.5 14.0 8.0
vertex 1.0 7.0 8.0

```
  endloop
endfacet
facet normal 0.0 0.0 −1.0
  outer loop
```

vertex 0.5 7.0 8.0
vertex 0.5 7.0 16.0
vertex 0.5 14.0 8.0

```
  endloop
endfacet
facet normal 0.577 0.577 0.577
  outer loop
```

vertex 1.0 7.0 8.0
vertex 0.5 14.0 8.0
vertex 0.5 7.0 16.0

endloop
endfacet

endsolid

The following code was used to generate these examples:

parameter = { 1:{1:.5 , 2:7 , 3:8 } , 2:{1:.5 , 2:2 , 3:1 } }
devicefnc = lambda x, y ,z: x*z[1] − z[2] + z[3]
product_specs = ″″″

solid cube_corner

facet normal 0.0 −1.0 0.0
outer loop

vertex 0.0 0.0 0.0
vertex 1.0 0.0 0.0
vertex 0.0 0.0 1.0

```
  endloop
endfacet
facet normal 0.0 0.0 −1.0
  outer loop
```

vertex 0.0 0.0 0.0
vertex 0.0 1.0 0.0
vertex 1.0 0.0 0.0

```
  endloop
endfacet
facet normal 0.0 0.0 −1.0
  outer loop
```

vertex 0.0 0.0 0.0
vertex 0.0 0.0 1.0
vertex 0.0 1.0 0.0

```
  endloop
endfacet
facet normal 0.577 0.577 0.577
  outer loop
```

vertex 1.0 0.0 0.0
vertex 0.0 1.0 0.0
vertex 0.0 0.0 1.0

endloop
endfacet

endsolid

″″″
parameter = { 1:{1:.5 , 2:7 , 3:8 } , 2:{1:.5 , 2:2 , 3:1 } }
def deviceenc (x, y, z, p):

return x*p[1] + p[1] , y*p[2] + p[2] , z*p[3] + p[3]

def devicefnc (x, y, z, p):

return (x − p[1])/p[1] , (y − p[2] )/p[2] , (z − p[3])/p[3]

print ‘Example encoding then decoding vertex\n′
print ′Original values : 1.0 , 0.0, 0.0 ′
val = deviceenc(1.0 , 0.0, 0.0 , parameter[1])
print ′Uniquely Encoded values : ′ ,val
print ′Decoded values : ′ , devicefnc(val[0], val[1], val[2] ,
parameter[1])
final_specs = [ ]
for line in product_specs.split(′\n′):

```
print line.rstrip(′\n′)
if line.find(′vertex′) > −1:
  vals = line.replace(′vertex′, ″).strip( )
  avals = vals.split(′ ′)
  enc_vals = deviceenc( float(avals[0]) , float(avals[1]),
  float(avals[2]),
```

parameter[1])

final_specs.append(′ vertex ′ + str(enc_vals[0]) + ′ ′ +

str(enc_vals[1]) + ′ ′ + str(enc_vals[2]) )

else:
final_specs.append(line.rstrip(′\n′) )

for line in final_specs:

print line.rstrip( )

These security techniques can be used in many different applications, such as for secure instant pharmaceutical manufacturing which is shown in FIG. 4. This can be used to perform rapid customization and manufacturing of pharmaceuticals in a safe, secure and cost effective manner.

The identity broker could provide a service that would enable prescriptions to be transmitted encoded based upon a patient's DNA or similar biometrics. This could operate as a cloud service that would check the prescriptions against patient's biometric data, and an instant manufacturing system that would provide a safe and anonymous means of creating prescriptions.

In this embodiment, the networked system as shown in FIG. 3 can include:
A database (e.g., within the centralized repository 108) of biometrics of individuals, including allergies.
A device to log medical prescriptions
An instant manufacturing device designed for “printing” medicine
A tracking system allowing users to input usages and biometric changes

The networked system of FIG. 3 can be used in the following manner. A doctor or medical personal prescribes a medication using a secure device. A secure device can be a computer, smart phone, or dedicated input device.

The prescription is encrypted using the patient's biometrics and transmitted to the identity broker's portal and database, which can be offered as cloud service. Biometrics keys could include:
DNA
Finger print
Face
Hair Sample
Random Number (if patient requests)

This service could scan the prescription against a patient's biometrics to look for items such known allergies. If prescriptions pass the check it would be routed based on available instant manufacturing facilities. Users can show up at any of the designated facilities and have their prescription printed out 24/7 in a completely anonymous fashion.

An instant manufacturing device (e.g., a 3-D printing device) could have a repository of the most commonly prescribed drugs and the base components for manufacturing additional drugs in an ad hoc fashion. Such a system could also customize prescription based on patients biometrics. A backend could provide alerts by monitoring the patients biometrics. The 3-D printing device can be secured using the techniques described herein.

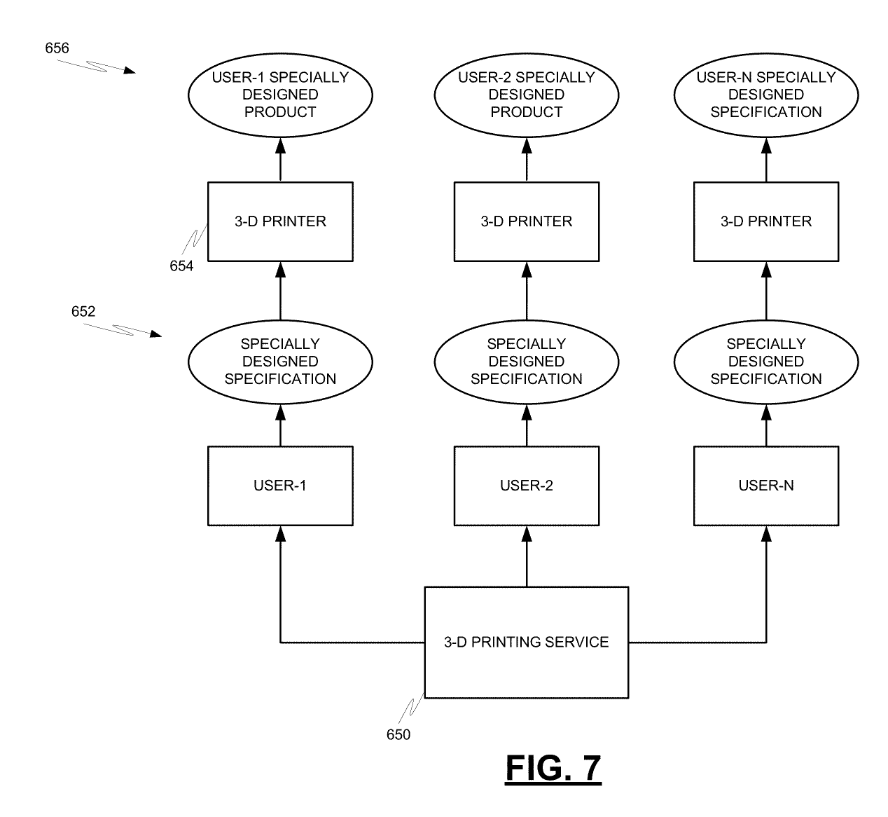

FIG. 7 illustrates another embodiment for securing a 3-D printer system by such methods as specially designing specifications 652 for that individual printer (e.g., printer 654). In this embodiment, a 3-D printing service 650 can be established that would enable people to operate as manufactures, such as by allowing them to create highly unique and personalized consumer products 656 which can be printed on the end user's home 3D printer.

Individuals can implement instant manufacturing wherein they can purchase a one-time use of an existing design to ‘print’ out their consumer good of choice. A design may originate from a major company or from another individual. In addition, “personalization” can be added to the end-user which would greatly enhance the offering.

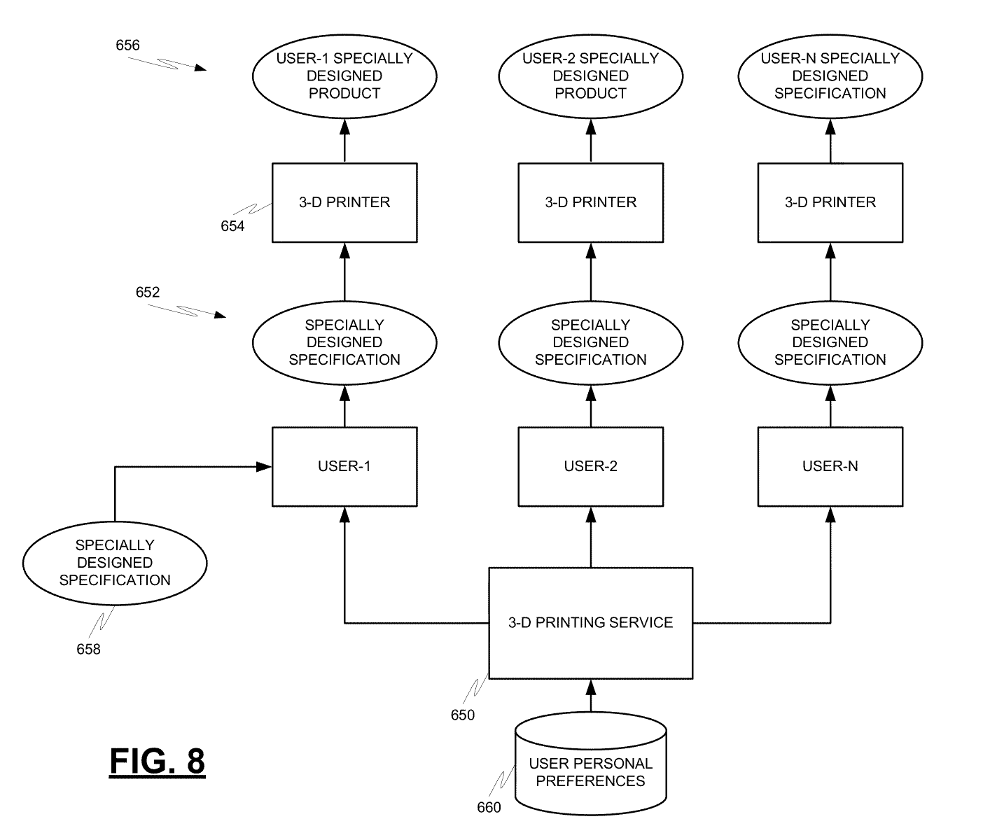

As shown in FIG. 8, the service 650 stores in database 660 personal information about user preferences in design selection for their customized products. Stated differently, the system would allow a user to customize a product to a degree that the template, even if shared would have less or no value to anyone else. Also, user features to be stored in database 660 can include, for example body dimensions, color preferences, preferred materials and the service would combine this data with the manufacture base template without revealing this information to the manufacture. This provides anonymity for the user but allows a manufacture to still create highly customized products. The company providing the 3-D printing service 650 could be a product broker and personal data anonymizer. The manufacture would not have to worry about consumer privacy concerns, and consumers can feel safe providing high personal data as the company stores the confidential information.

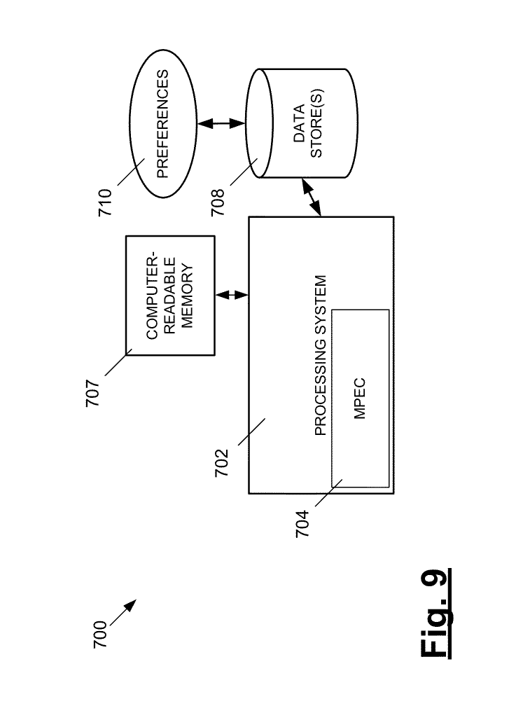

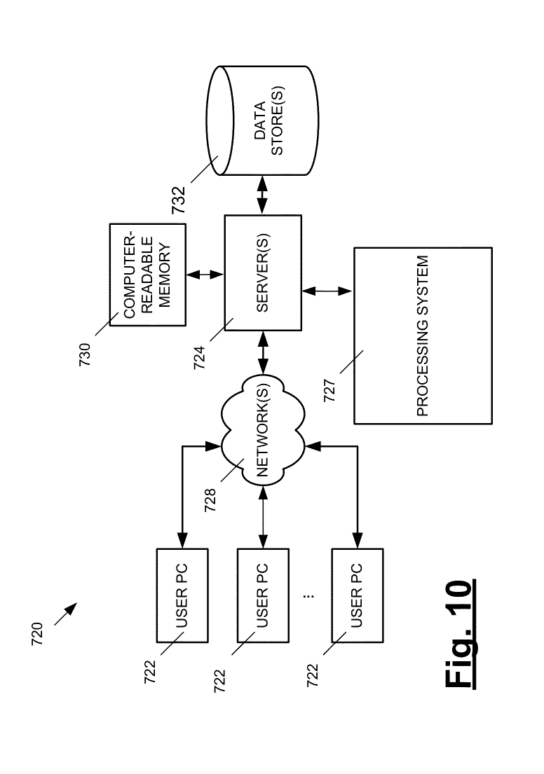

For computers or servers used within the approaches disclosed herein, FIGS. 9 and 10 depict example systems. FIG. 9 depicts an exemplary system 700 that includes a computer architecture where a processing system 702 (e.g., one or more computer processors located in a given computer or in multiple computers that may be separate and distinct from one another) includes software being executed on the processing system 702. The processing system 702 has access to a computer-readable memory 707 in addition to one or more data stores 708. The one or more data stores 708 may include user preferences 710. The processing system 702 may be a distributed parallel computing environment, which may be used to handle very large-scale data sets.

FIG. 10 depicts a system 720 that includes a client-server architecture. One or more user PCs 722 access one or more servers 724 running software 737 on a processing system 727 via one or more networks 728. The one or more servers 724 may access a computer-readable memory 730 as well as one or more data stores 732.

In FIGS. 9 and 10, computer readable memories (e.g., at 707) or data stores (e.g., at 708) may include one or more data structures for storing and associating various data used in the example systems. For example, a data structure stored in any of the aforementioned locations may be used to store device-specific data for use in secure operations.

Each of the element managers, real-time data buffer, conveyors, file input processor, database index shared access memory loader, reference data buffer and data managers may include a software application stored in one or more of the disk drives connected to the disk controller, the ROM and/or the RAM. The processor may access one or more components as required.

A display interface may permit information from the bus to be displayed on a display in audio, graphic, or alphanumeric format. Communication with external devices may optionally occur using various communication ports.

In addition to these computer-type components, the hardware may also include data input devices, such as a keyboard, or other input device, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure.

What is claimed is:

1. A computer-implemented method for secure instant manufacturing, the method comprising:
transmitting a product specification that contains instructions to an instant manufacturing controller for manufacturing a product;
storing encrypted fingerprints that are unique to the instant manufacturing controller;
wherein securing processing involving the product specification includes decryption of a unique, encrypted finger-print being required for an instant manufacturing controller to manufacture the product based on the product specification;
wherein the secure processing includes equations for the instant manufacturing controller that are sensitive to parameter misspecifications.

2. The method of claim 1, wherein the secure processing and instant manufacturing is performed by a user at home.

3. The method of claim 1, wherein the product specifications include at random intervals inert commands to obscure the product specifications.

4. The method of claim 1, wherein the secure processing ensures manufactures that the manufacturers can send product specifications without risk of the product specifications being pirated.

5. The method of claim 1, wherein the instant manufacturing device is a 3-D printer located at home.

6. The method of claim 1, wherein control and power modules of the instant manufacturing device are adapted to unique product data as derived off of a base product configuration;
wherein the control module contact service of an identity broker once a product has been assembled to download control codes for the secure processing.

7. The method of claim 1, wherein user preference data is stored for individual users to manufacture a specially designed product.

8. The method of claim 7, wherein the user preference data includes body dimensions, color preferences, or preferred materials.

9. The method of claim 8, wherein the user preference data is combined with a manufacture base template.

10. The method of claim 8, wherein the user preference data is combined with a manufacture base template without revealing the user preference data to the manufacture, thereby providing anonymity for a user but allowing a manufacture to still create highly customized products.

11. A computer-implemented system for secure instant manufacturing, comprising:
a memory; and
one or more processors disposed in communication with the memory and configured to issue processing instructions stored in the memory to:
transmit a product specification that contains instructions to an instant manufacturing controller for manufacturing a product;
store encrypted fingerprints that are unique to the instant manufacturing controller;
wherein securing processing involving the product specification includes decryption of a unique, encrypted finger-print being required for an instant manufacturing controller to manufacture the product based on the product specification;
wherein the secure processing includes equations for the instant manufacturing controller that are sensitive to parameter misspecifications.

12. The system of claim 11, wherein the secure processing and instant manufacturing is performed by a user at home.

13. The system of claim 11, wherein the product specifications include at random intervals inert commands to obscure the product specifications.

14. The system of claim 11, wherein the secure processing ensures manufactures that the manufacturers can send product specifications without risk of the product specifications being pirated.

15. The system of claim 11, wherein the instant manufacturing device is a 3-D printer located at home.

16. The system of claim ii, wherein control and power modules of the instant manufacturing device are adapted to unique product data as derived off of a base product configuration;
wherein the control module contact service of an identity broker once a product has been assembled to download control codes for the secure processing.

17. The system of claim 11, wherein user preference data is stored for individual users to manufacture a specially designed product.

18. The system of claim 17, wherein the user preference data includes body dimensions, color preferences, or preferred materials.

19. The system of claim 18, wherein the user preference data is combined with a manufacture base template.

20. The system of claim 18, wherein the user preference data is combined with a manufacture base template without revealing the user preference data to the manufacture, thereby providing anonymity for a user but allowing a manufacture to still create highly customized products.

21. A processor-readable non-transitory medium storing processor-issuable instructions for secure instant manufacturing, said instructions being processor-issuable to:
transmit a product specification that contains instructions to an instant manufacturing controller for manufacturing a product;
store encrypted fingerprints that are unique to the instant manufacturing controller;
wherein securing processing involving the product specification includes decryption of a unique, encrypted finger-print being required for an instant manufacturing controller to manufacture the product based on the product specification;
wherein the secure processing includes equations for the instant manufacturing controller that are sensitive to parameter misspecifications.
